(19) United States
(12) Patent Application Publication
(10) Pub. No.: US 2025/0060956 A1
(43) Pub. Date: Feb. 20, 2025

(54) System and Method for Automated Analysis of an Application

(71) Applicant: SLK SOFTWARE PVT. LTD., Bangalore (IN)

(72) Inventors: Shankaranarayana H ADIGA, Bangalore (IN); Manish JHA, Bangalore (IN); Vijaykumar E K, Bangalore (IN); Vidur AMIN, Spring, TX (US)

(21) Appl. No.: 18/807,166

(22) Filed: Aug. 16, 2024

(30) Foreign Application Priority Data
Aug. 17, 2023 (IN) 202341055302

(51) Int. Cl. G06F 8/65

(52) U.S. Cl. CPC G06F 8/65

(57) ABSTRACT

The present invention relates to a system and method for automated analysis of an application. The system has a database configured to store elements and properties of elements of a base version of the application and a processor configured to retrieve the elements and the properties of elements of the base version of the application, receive an updated version of the application, capture elements and properties of elements of the updated version of the application, compare the elements and the properties of elements of the base version of the application with the elements and the properties of elements of the updated version of the application, classify the elements of the updated version of the application based on the comparison. The processor is further configured to generate a report with details of the classified elements.

### CROSS-REFERENCE TO RELATED PATENT APPLICATION

This application claims priority to and the benefit of Indian Patent Application number 202341055302, filed Aug. 17, 2023, which is incorporated herein in its entirety by reference.

### FIELD OF THE INVENTION

The present invention relates to a system and method for automated analysis of an application.

### BACKGROUND OF THE INVENTION

In the dynamic and fast-paced software industry, applications continuously evolve and there are frequent updates. Applications consist of sophisticated elements with multifaceted functionality and complex behaviour. When a newer/updated version of an application is released, elements in the newer/updated version of the application are also modified. Due to the complex nature of applications, the existing method of identifying the modified elements in the newer/updated version of the application is laborious and time-consuming.

Additionally, as the applications continuously evolve by way of new versions, test scripts need to adapt/modify accordingly to remain effective. The conventional test automation tools lack the mechanism to efficiently identify and address the impact on existing test scripts when newer iterations or versions of the application are released. Consequently, automation scripts become outdated and are not effectively utilized, leading to increased reliance on manual testing efforts.

Presently, the maintenance of automation scripts up to date with the frequent release of new patches, upgrades, and versions of the applications and platforms largely relies on manual efforts. However, this manual approach to script maintenance is arduous, time-consuming, and error-prone, leading to delays in the testing process. This not only negatively impacts the application's time-to-market but also increases the overall testing cost and may result in wasted investments in automation tools.

Thus, there is a need in the art for a system and method for automated analysis of an application which addresses at-least the aforementioned problems.

### SUMMARY OF THE INVENTION

In one aspect, the present invention provides a system for automated analysis of an application. The system includes a user device that comprises a processor, a database, a memory unit, one or more input devices and one or more output devices. The database is configured to store elements and properties of elements of a base version of the application. The processor is configured to retrieve the elements and the properties of elements of the base version of the application. The processor is further configured to receive an updated version of the application and capture elements and properties of elements of the updated version of the application. The processor is further configured to compare the elements and the properties of the elements of the base version of the application with the elements and the properties of the elements of the updated version of the application. The processor is further configured to classify the elements of the updated version of the application based on the comparison. Herein, the classification of the elements of the updated version of the application includes at least one of unchanged element, deletion of the element, addition of new element and updation of the element. The processor is further configured to generate a report with details of the classified elements.

In an embodiment of the invention, the processor is configured to capture the elements and the properties of elements of the updated application by scanning the updated application and identifying elements therein.

In a further embodiment of the invention, the database is configured to store elements, properties of elements and associated test scripts of the elements of the base version of the application. The processor is configured to retrieve the associated test scripts of the elements of the base version of the application. The processor is further configured to identify the associated test scripts of the elements of the base version of the application to determine whether the associated test scripts are to be updated based on the classification. The processor is further configured to generate the report with details of the test script based on the identification.

In a further embodiment of the invention, the properties of elements of the base application and the updated version of the application include at least one of Xpath, Class, CSS selector, Object ID, name, Tag Name, Coordinates, Label and href.

In a further embodiment of the invention, the report includes a plurality of identification marks. Herein, each of the plurality of identification marks indicates the elements of the updated version of the application as at least one of unchanged element, deleted element, added element and updated element.

In a further embodiment of the invention, the report comprises a plurality of interactive links. Herein, each interactive link provides access to the associated test script determined for updation based on the classification of the elements of the updated version of the application.

In a further embodiment of the invention, the report includes one or more modules arranged in a hierarchical structure corresponding with a hierarchical structure of the application. Herein, the one or more modules comprise a main module corresponding to a parent node and a one or more sub modules corresponding to child nodes of the parent node, and each of the one or more modules include an interactive link.

In another aspect, the present invention relates to a method for automated analysis an application. The method includes the step of storing, by a processor, elements and properties of elements of a base version of the application in a database. Thereafter, the method includes the step of retrieving, by the processor, the elements and the properties of elements of a base version of the application. The method further has steps of receiving, by the processor, an updated version of the application and capturing, by the processor, elements and properties of elements of the updated version of the application. The method further has step of comparing, by the processor, the elements and the properties of the elements of the base version of the application with the properties of the elements of the updated version of the application. The method further has step of classifying, by the processor, the elements of the updated version of the application based on comparison. Herein, the classification of the elements of the updated version of the application includes at least one of unchanged element, deletion of the element, addition of new element and updation of the element. The method further has step of generating, by the processor, a report with details of classified elements.

In an embodiment of the invention, the elements and the properties of elements of the updated applications are captured by scanning the updated application and identifying elements therein.

In a further embodiment of the invention, the method has the step of storing, by the processor, elements, properties of elements and associated test scripts of the elements of the base version of the application in the database. The method further has the step of retrieving, by the processor, the associated test scripts of the elements of the base version of the application. The method further has the step of identifying, by the processor, the associated test scripts of the elements of the base version of the application to determine whether the associated test scripts are to be updated based on the classification. The method further has the step of generating, by the processor, the report with details of the test script based on the identification.

In a further embodiment of the invention, the properties of elements of the base application and the updated version of the application include at least one of Xpath, Class, CSS selector, Object ID, name, Tag Name, Coordinates, Label and href.

In a further embodiment of the invention, the report includes a plurality of identification marks. Herein, each of the plurality of identification marks indicates the elements of the updated version of the application as at least one of unchanged element, deleted element, added element and updated element.

In a further embodiment of the invention, the report comprises a plurality of interactive links. Herein, each interactive link provides access to the associated test script determined for updation based on the classification of the elements of the updated version of the application.

In a further embodiment of the invention, the report includes one or more modules arranged in a hierarchical structure corresponding with a hierarchical structure of the application. Herein, the one or more modules comprise a main module corresponding to a parent node and a one or more sub modules corresponding to child nodes of the parent node, and each of the one or more modules include an interactive link.

In one aspect, the present invention provides a system for automated analysis of an application. The system includes a user device that comprises a processor, a database, a memory unit, one or more input devices and one or more output devices. The database is configured to store elements, properties of elements and associated test scripts of the elements of a base version of the application. The processor is configured to retrieve the elements, the properties of elements and the associated test scripts of the elements of the base version of the application. The processor is further configured to receive an updated version of the application. The processor is further configured to capture elements and properties of elements of the updated version of the application and compare the properties of the elements of the base version of the application with the properties of the elements of the updated version of the application. The processor is further configured to classify the elements of the updated version of the application based on the comparison.

Herein, the classification of the elements of the updated version of the application includes at least one of unchanged element, deletion of the element, addition of new element and updation of the element. The processor is further configured to identify the associated test scripts of the elements of the base version of the application to determine whether the associated test scripts are to be updated based on the classification. The processor is further configured to generate a report with details of the test script that need to be updated/not updated based on the identification, enabling the user to navigate and modify the test script as required.

In another aspect, the present invention relates to a method for automated analysis an application. The method includes the step of storing, by a processor, elements, properties of elements and associated test scripts of the elements of a base application. Thereafter, the method includes the steps of retrieving, by the processor, the elements, the properties of elements and the associated test scripts of the elements of a base version of the application. The method further has the step of receiving, by the processor, an updated version of the application. The method further has the steps of capturing, by the processor, properties of elements of the updated version of the application and comparing the properties of the elements of the base version of the application with the properties of the elements of the updated version of the application. The method further has the steps of classifying, by the processor, the elements of the updated version of the application based on comparison. Herein, the classification of the elements of the updated version of the application includes at least one of unchanged element, deletion of the element, addition of new element and updation of the element. The method further has the steps of identifying, by the processor, the associated test scripts of the elements of the base version of the application to determine whether the associated test scripts are to be updated based on the classification. The method further has the steps of generating, by the processor, a report with details of the test script that need to be updated/not updated based on the identification, thereby enabling the user to navigate and modify the test script as required.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 illustrates a system for automated analysis of an application in accordance with an embodiment of the invention.

FIGS. 2A and 2B illustrates a report generated in accordance with an embodiment of the invention.

FIG. 3 illustrates a method for automated analysis of an application in accordance with an embodiment of the invention.

FIG. 4 illustrates a method for automated analysis of an application in accordance with an embodiment of the invention.

### DETAILED DESCRIPTION OF THE INVENTION

The present invention is directed towards a system and method for automated analysis of an application whereby when an updated/new version with new patches, upgrades of the application is released, the present invention determines an impact on elements of a base/old application, and test scripts associated with a base/old version of the application due to updated version the application. The present invention also generates a report which is structured, interactive and provides visual representation of the elements of the application impacted due to the update or the test script impacted due to the update. The report thus provides a clear indication of the application or test script that has been impacted. The report in relation to impacted test scripts allows users to edit part or whole of the test script for modifying the test script which may have been updated in cases where the application has been updated/modified.

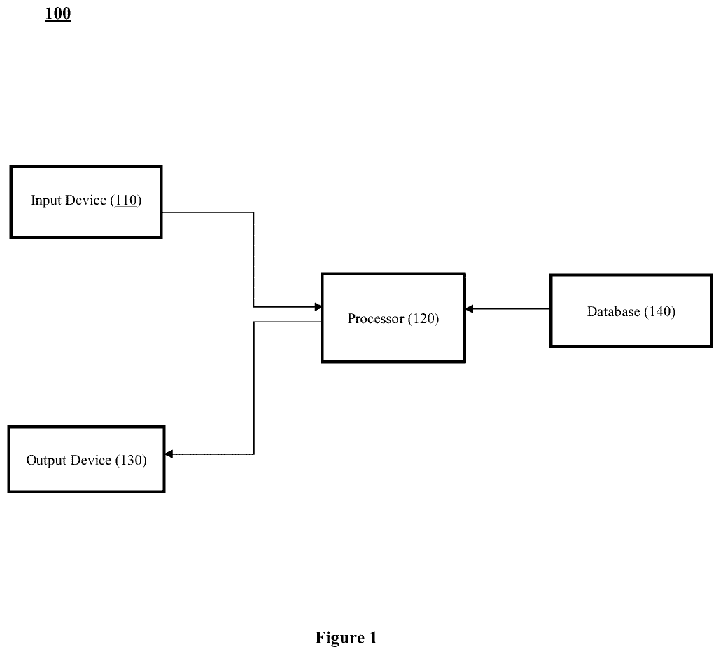

FIG. 1 illustrates a system 100 for automated analysis of an application. The application can be a web application, a desktop application, a mainframe, a mobile application or the like. The application can also include platforms such as enterprise resource planning (ERP), customer relationship management (CRM) or any packaged application. The system 100 includes a user device that comprises a processor 120, a database 140, a memory unit (not shown), one or more input devices 110 and one or more output devices 130. The one or more input devices 110 may include a keyboard and a mouse. The one or more output devices 130 may include at-least a display device. A user performs input actions on the application to be tested by using the one or more input devices 110.

In an embodiment a dedicated platform is installed on the user device for automated analysis of an application. Upon launching the dedicated platform, the user is allowed to select a base version of the application and an updated version of the application and thereafter perform an input action by selecting an option to carry out impact analysis of the updated version of the application. Accordingly, a skilled professional is not required for performing the required input actions. The impact analysis or the automated analysis of the application includes analysis of the updated version of the application vis-à-vis the base version of the application to determine impact of new patches, upgrades and versions on the application and/or test scripts associated with the base version of the application. The base version of the application may be a first or an old version of the application. The updated version of the application may be a newer version of the base application or may also include an implementation of a new patch to the base version of the application. In an embodiment, elements of the base version of the application, properties of elements of the base version of the application and associated test scripts of the elements of the base version of the application is stored on the database 140. The properties of elements of the base version of the application include Xpath, Class, CSS selector, Object ID, name, Tag Name, Coordinates, Label and href. The properties of the base application can be captured by selecting the elements of interest. The elements can be selected by an input device such as a mouse. Upon selection, the mouse inputs are disabled and event listeners fetch properties of the elements, and the same are stored. The properties of the base element can also be captured by other known methods.

In an embodiment, the impact or automated analysis can be carried out on the updated version to determine impact of new patches, upgrades and versions on the application or test scripts associated with the base version of the application. Accordingly, the user can select impact analysis on the application or impact analysis on the test scripts. Upon receiving the user input for impact analysis on the application, the processor 120 is configured to retrieve the elements and the properties of elements of the base application from the database 140. The processor 120 is further configured to receive an updated version of the application and capture elements and properties of elements of the updated version of the application. The elements and properties of elements are captured by scanning the application and identify elements therein. In this regard, the user interface of the application is scanned. For the identified elements, properties are determined. Thereafter, the processor 120 is configured to compare the properties of the elements of the base version with the properties of the elements of the updated version of the application. The comparison is performed by comparing the change in properties such as Xpath, Class, CSS selector, object ID, name, Tag Name, Coordinates, Label and href of the base version with the properties of the updated version of the application. The processor 120 is configured to classify the elements of the updated version of the application based on the comparison. The classification includes elements with no changes/unchanged element, deletion of the element, addition of new element and updation of the element in the updated version of the application. Similarly, upon receiving the user input for impact analysis on the test scripts, the processor 120 is configured to retrieve the elements, properties of elements and the associated test scripts of the elements of the base version of the application from the database 140. The processor 120 is further configured to capture properties of elements of the updated version of the application. Thereafter, the processor 120 is configured to compare the properties of the elements of the base version with the properties of the elements of the updated version of the application. The comparison is performed by comparing the change in properties such as Path, Class, CSS selector, object ID, name, Tag Name, Coordinates, Label and href of the base version with the properties of the updated version of the application. The processor 120 is configured to classify the elements of the updated version of the application based on the comparison. The classification includes elements with no changes, deletion of element, addition of new element and updation of element in the updated version of the application. The processor 120 is configured to identify the associated test scripts of the elements of the base application to determine whether the associated test scripts are to be unchanged/deleted/modified based on the classification.

The processor 120 is further configured to generate a report with details of the classified elements of the application that need to be modified/unchanged/deleted based on the identification and/or details of the elements of the test script that need to be modified/unchanged/deleted. The step of generating a report includes the step of updating a previous report associated with the base application. In an embodiment, the processor 120 is configured to generate a report that includes visual representation of the impacted element and the impacted test script. The report for impact analysis on application includes a separate/unique identification for the elements whereby the elements are modified, unchanged, or deleted. The report for impact analysis on test scripts includes a separate/unique identification for the elements whereby the test scripts are to be modified, unchanged, or deleted along with a dedicated link to access the relevant script. Accordingly, the report enables the user to navigate and deal with the test script as required. For example, when there is no change in the properties of the element in the updated application, the test script of the base application can be retained. When there is deletion of the element in the updated application, the associated test script of the deleted element can also be deleted. When an element is updated, the associated test script can also be accordingly updated. Similarly, when there is a newly added element in the updated application, the test script associated with the newly added element is to be generated. Automatic analysis of the base application enables the system 100 to complete the test script editing process quicker compared to when a user has to rewrite the test script set manually in an event of release of new patch or updation of the base application. Advantageously, the system is configured to analyse and determine impact on the elements and the test script when an application is upgraded, which efficiently streamlines the updating process of the test script eliminating manual time-consuming efforts while optimizing the testing process. This is also advantageous from a cost perspective.

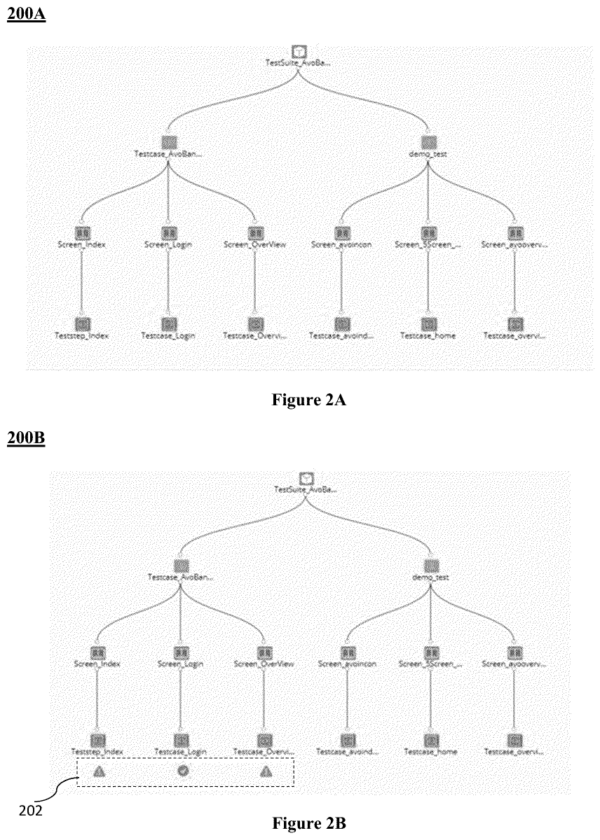

In another embodiment, the report categorizes the application as having one or more modules, and each module has one or more sub-modules. In this regard, the report captures all screens and elements of an application and their corresponding relationships, and basis the aforesaid, the report is a structured and visual form displayed on the output device 130. FIG. 2A shows an illustrative representation of a report 200A in accordance with an embodiment of the invention. By way of an example, FIG. 2A shows the report 200A of the base version of the application. FIG. 2B shows an illustrative representation of a report 200B generated upon release of the updated version of the application. As shown in FIGS. 2A and 2B, the report 200A, 200B comprises a mind map which has hierarchical and visual layout of the application. The reports as shown have a hierarchical structure, whereby a main module will be a parent node, and each of the one or more sub-modules will be a child node of the parent node. Depending on type of the application, the hierarchical structure will have multiple child nodes. Upon receiving the user input for impact analysis on the application, the report as shown in FIG. 2A is taken into consideration and the report as shown in FIG. 2B is generated. The report as shown in FIG. 2B visually represents the updated/unchanged/deleted elements enabling the users to identify the impacted elements in the updated version of the application. Similarly, upon receiving the user input for impact analysis on the test scripts, the report as shown in FIG. 2B visually represents the updated/unchanged/deleted test scripts enabling the users to identify the impacted test script along with a dedicated link to access the respective test script. Thus, by accessing the corresponding link, the specific script can be accessed. Further, the report for impact analysis on application and test scripts includes a separate/unique identification such as indicia 202 that provides visual representation of the elements of the application impacted due to the update or the test script impacted due to the update. A unique indicia can be associated for each aspect of updated or unchanged or deleted or new element. By way of an example, the report 200A, 200B is generated for a login page of a website/application. In particular, the report 200B is generated upon comparing the properties of the elements of the base version of the login page with the properties of the elements of the updated version of the login page. Similar reports are generated for other pages of the website/application. As shown, the report 200B includes a separate/unique identification such as indicia 202 that provides visual representation of the elements of the application impacted due to the update or the test script impacted due to the update. Further, the report 200B comprises a plurality of interactive links providing access to the associated test script determined for updation based on the classification of the elements of the updated version of the application. Accordingly, depending upon type of update, the script can be updated/unchanged/deleted, and the user does not need to update the entire script from the beginning. Thus, the part of the script which is to be modified can be easily accessed.

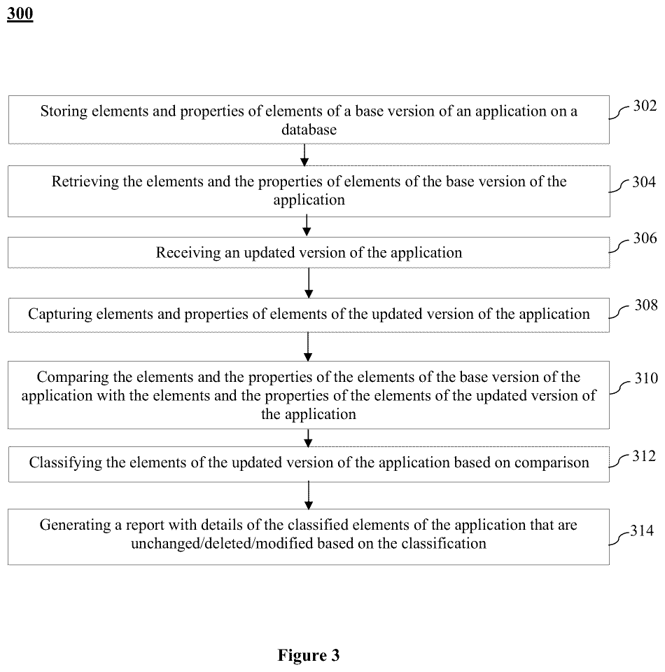

FIG. 3 illustrates a method 300 for automated analysis of an application. The method 300 is executed on the system 100 discussed hereinbefore. The method 300 at step 302, includes storing, by a processor 120140, elements, properties of elements of a base version of an application in a database 140. Thereafter, at step 304, the method 300 includes retrieving, by a processor 120, the elements, the properties of elements of the base version of the application. Thereafter, at step 306, the method 300 includes receiving an updated version of the application. At step 308, the method 300 includes capturing elements and properties of elements of the updated version of the application. The elements and the properties of elements of the updated applications are captured by scanning the updated application and identifying elements therein. The properties of elements of the base application and the updated version of the application include at least one of Xpath, Class, CSS selector, Object ID, name, Tag Name, Coordinates, Label and href. Thereafter, at step 310, the method 300 includes comparing the properties of the elements of the base version of the application with the properties of the elements of the updated version of the application. At step 312, the method 300 includes classifying the elements of the updated version of the application based on comparison. The classification of the elements of the updated version of the application includes at least one of unchanged element, deletion of the element, addition of new element and updation of the element. Thereafter, at step 314, the method 300 includes generating a report 200B with details of the classified elements of the application that are unchanged/deleted/modified. The report 200B as shown in FIG. 2 includes a plurality of identification marks 202. Each of the plurality of identification marks 202 indicates the elements of the updated version of the application as at least one of unchanged element, deleted element, added element and updated element.

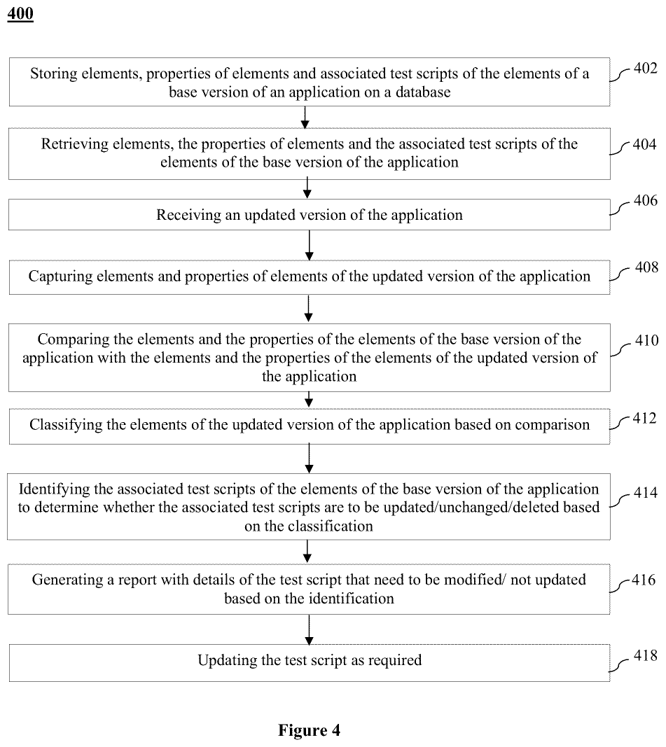

FIG. 4 illustrates a method 400 for automated analysis of an application. The method 400 is executed on the system 100 discussed hereinbefore. The method 400 at step 402, includes storing, by a processor 120, elements, properties of elements and associated test scripts of the elements of a base version of the application in a database 140. Thereafter, at step 404, the method 400 includes retrieving, by the processor 120, the elements, the properties of elements and the associated test scripts of the elements of the base version of the application. Thereafter, at step 406, the method 400 includes receiving an updated version of the application. At step 408, the method 400 includes capturing properties of elements of the updated version of the application. Thereafter, at step 410, the method 400 includes comparing the properties of the elements of the base version of the application with the properties of the elements of the updated version of the application. At step 412, the method 400 includes classifying the elements of the updated version of the application based on comparison. Thereafter, at step 414, the method 400 includes identifying the associated test scripts of the elements of the base version of the application to determine whether the associated test scripts are to be updated/unchanged/deleted based on the classification. Thereafter, at step 416, the method 400 includes generating a report with details of the test script that need to be modified/not updated based on the identification. The report 200B as shown in FIG. 2 comprises a plurality of interactive links, each interactive link provides access to the associated test script determined for updation based on the classification of the elements of the updated version of the application. In a non-limiting example, the report 200B includes one or more modules arranged in a hierarchical structure corresponding with a hierarchical structure of the application, the one or more modules comprise a main module corresponding to a parent node and a one or more sub modules corresponding to child nodes of the parent node, and each of the one or more modules include an interactive link. Thereafter, at step 418, the method 400 includes updating the test script based on a user input, thereby enabling the user to navigate and modify the script as required.

Advantageously, the present invention provides a system and method for automated analysis of an application that enable reliable and accurate identification of the updated/modified elements in the newer/updated version of the application. Further, the present invention provides a system and method for automated analysis of an application that eliminate the need for manual intervention to update a test script associated with a base application when the base application is upgraded. As the system is configured to analyse and determine impact on the test script when an application is upgraded, the system efficiently streamlines the updating process of the test script reducing manual time-consuming efforts while optimizing the testing process. This results in improved efficiency and substantial reduction in testing costs. Further, such automation saves time, effort and resources of the organization performing the testing. In addition, the present invention generates a report that provides a visual representation of the impacted test script and allowing a user to edit part or whole of the test script for modifying the test script as required. This leads to optimal utilization of resources thereby enhancing the overall efficiency and accuracy of the testing process. Furthermore, the present invention can be plugged with other automation testing tools.

The foregoing description of the invention has been set merely to illustrate the invention and is not intended to be limiting. Since the modifications of the disclosed embodiments incorporating the spirit and substance of the invention may occur to the person skilled in the art, the invention should be construed to include everything within the scope of the invention.

We claim:

1. A system (100) for automated analysis of an application, the system (100) comprising:
a database (140) configured to store elements and properties of elements of a base version of the application; and
a processor (120) configured to:
retrieve the elements and the properties of elements of the base version of the application;
receive an updated version of the application;
capture elements and properties of elements of the updated version of the application;
compare the elements and the properties of elements of the base version of the application with the elements and the properties of elements of the updated version of the application;
classify the elements of the updated version of the application based on the comparison, the classification of the elements of the updated version of the application includes at least one of unchanged element, deletion of the element, addition of new element and updation of the element; and
generate a report (200B) with details of the classified elements.

2. The system (100) as claimed in claim 1, wherein the processor is configured to capture the elements and the properties of elements of the updated application by scanning the updated application and identifying elements therein.

3. The system (100) as claimed in claim 1, wherein the database (140) is configured to store elements, properties of elements and associated test scripts of the elements of the base version of the application; and the processor (120) is configured to:
retrieve the associated test scripts of the elements of the base version of the application,
identify the associated test scripts of the elements of the base version of the application to determine whether the associated test scripts are to be updated based on the classification, and
generate the report (200B) with details of the test script based on the identification.

4. The system (100) as claimed in claim 1, wherein the properties of elements of the base application and the updated version of the application include at least one of Xpath, Class, CSS selector, Object ID, name, Tag Name, Coordinates, Label and href.

5. The system (100) as claimed in claim 1, wherein the report (200B) includes a plurality of identification marks (202), each of the plurality of identification marks (202) indicates the elements of the updated version of the application as at least one of unchanged element, deleted element, added element and updated element.

6. The system (100) as claimed in claim 3, wherein the report (200B) comprises a plurality of interactive links, each interactive link provides access to the associated test script determined for updation based on the classification of the elements of the updated version of the application.

7. The system (100) as claimed in claim 1, wherein the report (200B) includes one or more modules arranged in a hierarchical structure corresponding with a hierarchical structure of the application, the one or more modules comprise a main module corresponding to a parent node and a one or more sub modules corresponding to child nodes of the parent node, and each of the one or more modules include an interactive link.

8. A method (300, 400) for automated analysis of an application, the method (300, 400) comprising steps of:
storing, by a processor (120), elements and properties of elements of a base version of the application in a database (140);
retrieving, by the processor (120), the elements and the properties of elements of the base version of the application;
receiving, by the processor (120), an updated version of the application;
capturing, by the processor (120), elements and properties of elements of the updated version of the application;
comparing, by the processor (120), the elements and the properties of elements of the base version of the application with the elements and the properties of elements of the updated version of the application;
classifying, by the processor (120), the elements of the updated version of the application based on the comparison, the classification of the elements of the updated version of the application includes at least one of unchanged element, deletion of the element, addition of new element and updation of the element; and
generating, by the processor (120), a report (200B) with details of the classified elements.

9. The method (300, 400) as claimed in claim 8, wherein the elements and the properties of elements of the updated applications are captured by scanning the updated application and identifying elements therein.

10. The method (300,400) as claimed in claim 8 comprising the step of:
storing, by the processor (120), elements and properties of elements and associated test scripts of the elements of the base version of the application in the database (140);
retrieving, by the processor (120), the associated test scripts of the elements of the base version of the application;
identifying, by the processor (120), the associated test scripts of the elements of the base version of the application to determine whether the associated test scripts are to be updated based on the classification; and
generating, by the processor (120), the report (200B) with details of the test script based on the identification.

11. The method (300, 400) as claimed in claim 8, wherein the properties of elements of the base application and the updated version of the application include at least one of Xpath, Class, CSS selector, Object ID, name, Tag Name, Coordinates, Label and href.

12. The method (300, 400) as claimed in claim 8, wherein the report (200B) includes a plurality of identification marks (202), each of the plurality of identification marks (202) indicates the elements of the updated version of the application as at least one of unchanged element, deleted element, added element and updated element.

13. The method (300, 400) as claimed in claim 10, wherein the report (200B) comprises a plurality of interactive links, each interactive link provides access to the associated test script determined for updation based on the classification of the elements of the updated version of the application.

14. The method (300, 400) as claimed in claim 8, wherein the report (200B) includes one or more modules arranged in a hierarchical structure corresponding with a hierarchical structure of the application, the one or more modules comprise a main module corresponding to a parent node and a one or more sub modules corresponding to child nodes of the parent node, and each of the one or more modules include an interactive link.
